(19) United States
(12) Patent Application Publication
(10) Pub. No.: US 2016/0268608 A1
(43) Pub. Date: Sep. 15, 2016

(54) LITHIUM SECONDARY BATTERY, POWER STORAGE APPARATUS INCLUDING LITHIUM SECONDARY BATTERY AND METHOD OF MANUFACTURING LITHIUM SECONDARY BATTERY

(71) Applicant: HITACHI, LTD., Tokyo (JP)

(72) Inventors: Etsuko NISHIMURA, Tokyo (JP); Takefumi OKUMURA, Tokyo (JP); Yoshiyuki TAKAMORI, Tokyo (JP); Akihiko NOIE, Tokyo (JP); Chieko ARAKI, Tokyo (JP); Kazuaki NAOE, Tokyo (JP); Shimpei AMASAKI, Tokyo (JP)

(73) Assignee: HITACHI, LTD., Tokyo (JP)

(21) Appl. No.: 14/982,321

(22) Filed: Dec. 29, 2015

(30) Foreign Application Priority Data
Jan. 14, 2015 (JP) 2015-005311

(51) Int. Cl. H01M 4/62; H01M 4/04; H01M 10/0525

(52) U.S. Cl. CPC H01M 4/625; H01M 10/0525; H01M 4/0471

(57) ABSTRACT

A lithium secondary battery having a positive electrode, a negative electrode, and an electrolyte, wherein the positive electrode is constituted by a positive electrode mixture layer containing a positive electrode active material, a binder, and a conductive agent being formed on a positive electrode collector, the negative electrode is constituted by a negative electrode mixture layer containing a negative electrode active material, the binder, and the conductive agent being formed on a negative electrode collector, and the conductive agent contained in both of the positive electrode mixture layer and the negative electrode mixture layer is a fibrous conductive agent or a mixture of the fibrous conductive agent and a particulate conductive agent and an aspect ratio of the fibrous conductive agent is 20 or more.

### BACKGROUND OF THE INVENTION

1. Field of the Invention

The present invention relates to a lithium secondary battery, and in particular, relates to a lithium secondary battery superior in output characteristics.

2. Description of the Related Art

A lithium secondary battery has a high energy density and attracts attention as a battery for electric cars and power storage. For hybrid electric vehicles, particularly a lithium secondary battery exhibiting excellent output characteristics in a large-current charge and discharge is required.

As a conventional technology to improve output characteristics of a lithium secondary battery, a denatured organic metal complex obtained by heating an organic metal complex and/or a metal element is included in a negative electrode active material layer containing Si and/or Sn and a conductivity higher than 1×10⁶ S/m can be obtained preventing the denatured organic metal complex and the metal element from being alloyed with Li, which is disclosed by JP 2011-065812 A. Also, a secondary battery in which a porosity A1 of a positive electrode mixture layer is 0.30≦A1 and a porosity A2 of a negative electrode mixture layer is 0.30≦A2 is disclosed by WO 2012/063370.

### SUMMARY OF THE INVENTION

A lithium secondary battery has a structure in which a positive electrode and a negative electrode having a positive electrode mixture layer and a negative electrode mixture layer formed on the surface of a positive electrode collector and a negative electrode collector respectively are accommodated in a battery container via a separator and the battery container is filled with an electrolytic solution and sealed. The positive electrode mixture includes a positive electrode active material, a conductive agent, and a binder. The negative electrode mixture includes a negative electrode active material, a conductive agent, and a binder. To implement a lithium secondary battery superior in output characteristics, it is necessary to simultaneously realize an increase of an electrolytic solution holding amount in the electrode mixture layer of the lithium secondary battery (that is, the same as the void volume of the electrode) and a decrease of electronic resistance of the electrode mixture layer. The electrolytic solution holding amount depends on the volume of voids in the electrode mixture layer and increases with an increasing volume of voids. However, if the volume of voids is increased, connected states between active material particles in the electrode mixture layer deteriorate and electronic resistance in the electrode increases, which does not improve output characteristics of the lithium secondary battery. Conversely, if the filling ratio of the active material or the conductive agent contained in the electrode mixture layer is increased to decrease electronic resistance, the volume of voids decreases and the electrolytic solution holding amount decreases, and thus, output characteristics of the lithium secondary battery are not improved.

(Consideration of the Electrode)

Here, the percentage of voids of an electrode mixture layer will be considered with reference to FIGS. 2 to 5. The present consideration does not distinguish between the positive electrode and the negative electrode. FIGS. 2 to 5 schematically show the structure inside the active material layer of an electrode. In FIG. 2, nine active material particles 151 in which three particles are arranged vertically and horizontally form a planar structure and further, the planar structure is arranged in three rows to form a closest packing structure of 27 active material particles. The active material particle 151 is assumed to have a spherical shape of a fixed radius. The planar structure in which the nine active material particles 151 are arranged is called a front row, a middle row, and a back row from the front side toward the back side. If it is assumed that such a closest packing structure is formed in the whole electrode mixture layer, the ratio of the volume occupied by active material particles in the electrode mixture layer is 52%. Therefore, the percentage of voids is 48%.

To make the description of the percentage of voids easier, an active material particle 152 in the center of the middle row is represented by a black circle (). The active material particle 152 is in contact with six other active material particles 151a, 151b, 151c, 151d, 151e, 151f.

FIG. 3 shows a case in which the one active material particle 151d is removed. In this case, the active material particle 152 is in contact with each of the other five active material particles 151a, 151b, 151c, 151e, 151f. If it is assumed that the structure as shown in FIG. 3 is formed in the whole electrode mixture layer, the percentage of voids of the electrode mixture layer becomes 51%.

FIG. 4 shows a case in which the percentage of voids is further increased. That is, a case in which the active material particles 151b, 151c, 151e in the middle row are removed is shown. In this case, the active material particle 152 is in contact with each of the other two active material particles 151a, 151f. If it is assumed that the structure as shown in FIG. 4 is formed in the whole electrode mixture layer, the percentage of voids of the electrode mixture layer becomes 61%.

Next, an electric connection between active material particles will be described with reference to FIGS. 5 and 6. To make the description easier, FIG. 5 shows a state in which only the two active material particles 151a, 151f are in contact on both sides of the active material particle 152. Each of the active material particles 151a, 151f is further in contact with other active material particles (not shown).

FIG. 6 schematically shows a state when a particulate conductive agent, for example, particulate carbon (such as carbon black, graphite or the like) is used as the conductive agent in the structure of active material particles shown in FIG. 5. In this case, mixed particles 153 of the particulate conductive agent and the binder are present near the interface between the active material particle 152 and the active material particle 151a and near the interface between the active material particle 152 and the active material particle 151f and an excellent electric connection between active material particles can thereby be realized. That is, a conductive network is configured throughout the electrode mixture layer.

In a lithium secondary battery, however, active material particles repeat expansion and contraction accompanying the charge and discharge. As a result, a case in which a gap arises between active material particles can be considered and in such a case, a gap arises between active material particles and the mixed particles 153. As a result, an electric connection between active material particles is lost. That is, a conductive network is impaired. This description similarly applies to the configurations shown in FIGS. 2 to 4.

According to a first aspect of the present invention, a lithium secondary battery having a positive electrode, a negative electrode, and an electrolyte, wherein the positive electrode is constituted by a positive electrode mixture layer containing a positive electrode active material, a binder, and a conductive agent being formed on a positive electrode collector, the negative electrode is constituted by a negative electrode mixture layer containing a negative electrode active material, the binder, and the conductive agent being formed on a negative electrode collector, a thickness of the positive electrode mixture layer is 40 μm or less, a percentage of voids of the positive electrode mixture layer is 40% or more and 55% or less, an average particle size of the positive electrode active material is 1 μm or more and 5 μm or less, a volume of the conductive agent in the positive electrode mixture layer is 10% or more and 40% or less of the volume of the binder, and the conductive agent contained in both of the positive electrode mixture layer and the negative electrode mixture layer is a fibrous conductive agent or a mixture of the fibrous conductive agent and a particulate conductive agent and an aspect ratio (radio of a diameter to a length of the fibrous conductive agent) of the fibrous conductive agent is 20 or more.

According to a second aspect of the present invention, a power storage apparatus including a lithium secondary battery, wherein the lithium secondary battery is the lithium secondary battery according to the first aspect.

According to a third aspect of the present invention, a method of manufacturing the lithium secondary battery according to the first aspect, including forming a positive electrode mixture layer containing a fibrous conductive agent on a positive electrode collector, forming a negative electrode mixture layer containing the fibrous conductive agent on a negative electrode collector, and holding the positive electrode collector on which the positive electrode mixture layer is formed and the negative electrode collector on which the positive electrode mixture layer is formed at 100° C. or more and 300° C. or less for a predetermined time.

According to the present invention, a lithium secondary battery superior in output characteristics can be provided.

### BRIEF DESCRIPTION OF THE DRAWINGS

FIG. 1 is a diagram schematically showing an internal structure of a lithium secondary battery;

FIG. 2 is a diagram schematically showing the structure inside an active material layer of an electrode;

FIG. 3 is a diagram schematically showing the structure inside the active material layer of the electrode;

FIG. 4 is a diagram schematically showing the structure inside the active material layer of the electrode;

FIG. 5 is a diagram schematically showing the structure inside the active material layer of the electrode;

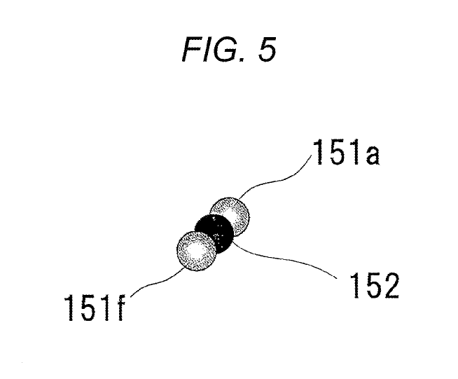

FIG. 6 is a diagram showing an electric connection between active material layer particles by a particulate conductive agent;

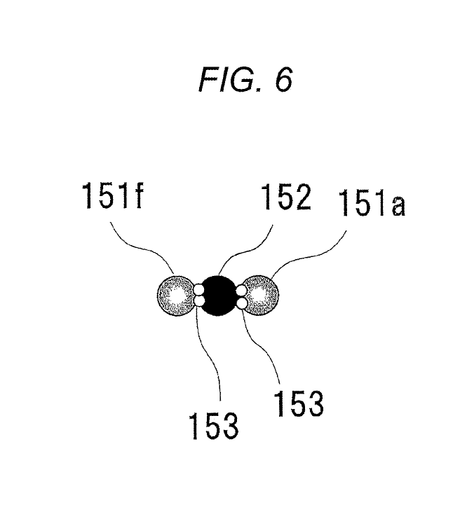

FIG. 7 is a diagram showing the electric connection between active material layer particles by a fibrous conductive agent;

FIG. 8 is a table showing the configuration of lithium secondary batteries of examples;

FIG. 9 is a table showing the configuration of lithium secondary batteries of examples;

FIG. 10 is a table showing a 1C discharge capacity, a capacity maintenance rate, and a 5C discharge capacity ratio of lithium secondary batteries of examples;

FIG. 11 is a table showing the configuration of lithium secondary batteries of examples;

FIG. 12 is a table showing the 1C discharge capacity, the capacity maintenance rate, and the 5C discharge capacity ratio of lithium secondary batteries of examples;

FIG. 13 is a table showing the configuration of lithium secondary batteries of comparative examples;

FIG. 14 is a table showing the configuration of lithium secondary batteries of comparative examples;

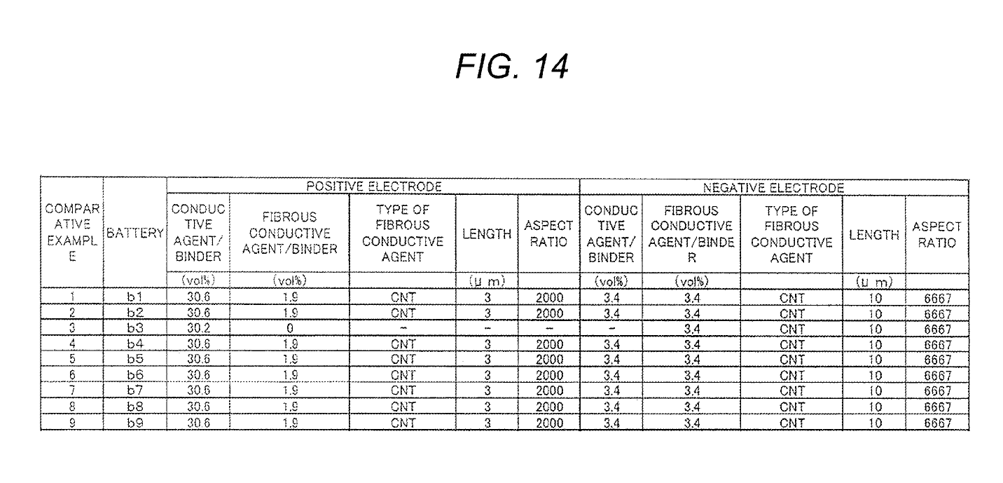

FIG. 15 is a table showing the 1C discharge capacity, the capacity maintenance rate, and the 5C discharge capacity ratio of lithium secondary batteries of comparative examples; and

FIG. 16 is a conceptual diagram showing an outline configuration of a charging apparatus.

### DESCRIPTION OF THE PREFERRED EMBODIMENTS

### First Embodiment

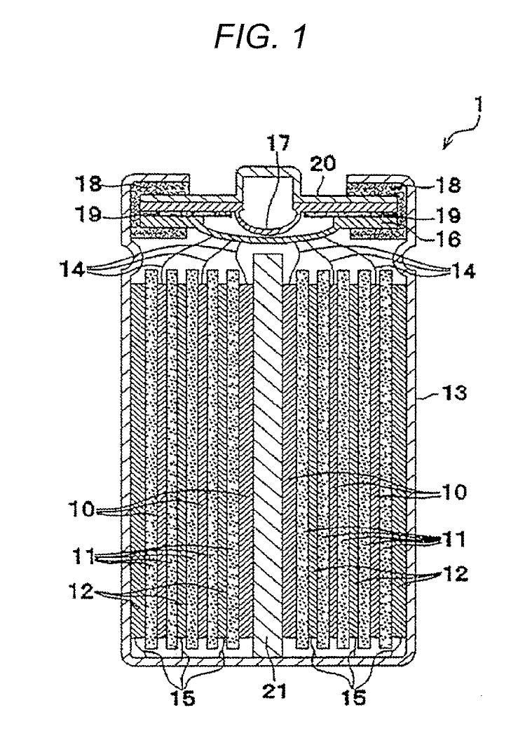

Hereinafter, the present invention will be described with reference to the drawings. FIG. 1 is a diagram schematically showing an internal structure of a lithium secondary battery. A lithium secondary battery 1 shown in FIG. 1 includes a positive electrode 10, a negative electrode 12, a battery container (battery can) 13, a positive electrode current collecting tab 14, a negative electrode current collecting tab 15, an inner lid 16, an internal pressure release valve 17, a gasket 18, a positive temperature coefficient (PTC) resistance element 19, a battery lid 20, and an axial center 21. The battery lid 20 is configured integrally with the inner lid 16, the internal pressure release valve 17, the gasket 18, and the PTC resistance element 19. The PTC resistance element 19 is used to protect a lithium secondary battery by stopping the charge and discharge of the battery when the temperature inside the battery rises.

An electrode group including the positive electrode 10, the negative electrode 12, and the separator 11 inserted therebetween is configured by being wound around the axial center 21. Any publicly known axial center capable of holding the positive electrode 10, the separator 11, and the negative electrode 12 may be used as the axial center 21. In addition to the cylindrical shape shown in FIG. 1, the electrode group may adopt various shapes such as a laminate in which electrodes in a thin rectangular shape are laminated, a winding in which the positive electrode 10 and the negative electrode 12 are wound into any shape such as a flat shape and the like. The shape of the battery container 13 may be selected, by adjusting to the shape of the electrode group, from shapes such as a cylindrical shape, a flat oblong shape, flat elliptical shape, and a rectangular shape.

The material of the battery container 13 is selected from materials corrosion-resistant to a nonaqueous electrolyte such as nickel, titanium, stainless steel, and nickel-plated copper. If the battery container 13 is electrically connected to the positive electrode 10 or the negative electrode 12, the material of the battery container 13 is selected such that a portion of the battery container 13 in contact with the nonaqueous electrolyte is not corroded or denatured by alloying with lithium ions.

A battery group is housed in the battery container 13, the negative electrode current collecting tab 15 is connected to the inner wall of the battery container 13, and the positive electrode current collecting tab 14 is connected to the bottom of the battery lid 20. The current collecting tabs 14, 15 are structured to be able to reduce an ohmic loss when a current is passed and various materials, which do not react with the electrolytic solution, and shapes can be adopted in accordance with the structure of the battery container. For example, shapes such as a wire shape or a plate shape can be used. The electrolytic solution is injected into the battery container 13. As methods of injecting the electrolytic solution, a method of directly injecting the electrolytic solution into an electrode group while the battery lid 20 is open and a method of injecting the electrolytic solution from an injection port provided in the battery lid 20 are known. After the electrolytic solution is injected, the battery lid 20 is brought into close contact with the battery container 13 to airtightly seal the whole battery. If the injection port of the electrolytic solution is present, the injection port is also airtightly sealed. Publicly known technologies such as welding and caulking can be used as the method of airtightly sealing the battery.

(Positive Electrode)

The positive electrode 10 is produced by forming a positive electrode mixture layer on the surface of a positive electrode collector. The positive electrode mixture layer includes a positive electrode active material, a conductive agent, and a binder. Typical materials of the positive electrode mixture layer include LiCoO₂, LiNiO₂, and Limn₂O₄. In addition to the above materials, LiMnO₃, LiMn₂O₃, LiMnO₂, Li₄Mn₅O₁₂, LiMn₂₋ₓMxO₂ (where x=0.01 to 0.2, M is one or more of Co, Ni, Fe, Cr, Zn, and Ta), Li₂Mn₃MO₈ (where M is one or more of Fe, Co, Ni, Cu, and Zn), Li₁₋ₓAₓMn₂O₄ (where x=0.01 to 0.1, A is one or more of Mg, B, Al, Fe, Co, Ni, Cr, Zn, and Ca), LiNi₁₋ₓMₓO₂ (where x=0.01 to 0.2, M is one or more of Co, Fe, and Ga), LiFeO₂, Fe₂ (SO₄)₃, LiCo₁₋ₓMₓO₂ (where x=0.01 to 0.2, M is one or more of Ni, Fe, and Mn), LiNi₁₋ₓMₓO₂ (where x=0.01 to 0.2, M is one or more of Mn, Fe, Co, Al, Ga, Ca, and Mg), Fe (MoO₄)₃ FeF₃, LiFePO₄, and LiMnPO₄ can be cited. In the present embodiment, LiNi_{1/3}Mn_{1/3}Co_{1/3}O₂ was used as the material of the positive electrode active material. The present invention is not limited by the material of the positive electrode active material and a similar effect can be gained by using any of the above materials as the positive electrode active material.

In the positive electrode 10, the thickness of the positive electrode mixture layer is set to 40 μm or more, the percentage of voids thereof is set to 40% or more and 55% or less, and the average particle size of the positive electrode active material is set to 1 μm or more and 5 μm or less. If the percentage of voids is less than 40%, it becomes difficult for the electrolytic solution to come into contact with all positive electrode active material particles, making it difficult for a portion of the positive electrode active material to charge and discharge. On the other hand, if the percentage of voids exceeds 55%, contact between positive electrode active material particles is less likely, making it impossible to exchange electrons with a portion of positive electrode active material particles.

The positive electrode active material is an oxide based material and has a high electric resistance and thus, the positive electrode mixture layer is caused to contain a conductive agent to ensure electric conductivity. The total volume of the conductive agent the positive electrode mixture layer is caused to contain is 10% or more and 40% or less of the total volume of the binder. The conductive agent is a fibrous conductive agent or a mixture of a fibrous conductive agent and a particulate conductive agent and the aspect ratio (ratio of the diameter to the length of the conductive fiber) of the fibrous conductive agent is 20 or more. The total volume of the fibrous conductive agent contained in the conductive agent is preferably 0.04% or more and 0.5% or less of the total volume of the binder.

While carbon nanotubes, carbon fibers, metal fibers or the like can be used as the fibrous conductive agent, the fibrous conductive agent is preferably one of the carbon nanotubes and carbon fiber and the total mass of the fibrous conductive agent is preferably 0.1% or more of the total mass of the positive electrode active material. The carbon fiber is preferably vapor growth carbon fiber. The lower limit of the length of the fibrous conductive agent is preferably larger than the average radius of the positive electrode active material. On the other hand, if the fibrous conductive agent is flexible, the upper limit of the length of the fibrous conductive agent is not particularly set and if the rigidity thereof is relatively high, for example, the fibrous conductive agent is vapor growth carbon fiber, the length thereof is particularly preferably smaller than double the average radius of the positive electrode active material (that is, the average particle size of the positive electrode active material). For example, the length of the fibrous conductive agent can be set to 1 to 10 μm.

The diameter of the fibrous conductive agent is preferably 1 to 500 nm and particularly preferably 10 to 200 nm. The fibrous conductive agent preferably couples a plurality of positive electrode active materials by constituting a self-organizing conductive network while being held by the binder. The self-organization is to form a conductive network inside the binder by the conductive agent being rearranged by heat treatment. Only the fibrous conductive agent may be used or a mixture of the fibrous conductive agent and particulate conductive agent may be used as the conductive agent. As the particulate conductive agent, particulate carbon such as acetylene black, carbon black, graphite, and amorphous carbon can be used. The particle size of the particulate conductive agent is smaller than the average particle size of the positive electrode active material and is preferably 1/10 or less of the average particle size.

The positive electrode mixture layer preferably does not contain positive electrode active material particles whose size exceeds the thickness of the positive electrode mixture layer. If large positive electrode active material particles whose size exceeds the thickness of the positive electrode mixture layer are contained, electronic conductivity between neighboring positive electrode active material particles is considered to deteriorate. Therefore, it is preferable to remove such large positive electrode active material particles in advance by sieve classification, wind-flow classification or the like.

(Production of the Positive Electrode)

Next, the production of the positive electrode will be described. A positive electrode collector is prepared. Aluminum foil of 10 to 100 μm in thickness, punched foil made of aluminum whose thickness is 10 to 100 μm and having many holes of 0.11 to 10 mm in hole diameter formed therein, expanded metal made of aluminum, foamed aluminum plate or the like can be used as the positive electrode collector. In addition to aluminum, stainless steel or titanium can be used as the material thereof. No restriction is imposed on the material, shape, or manufacturing method that does not undergo a change such as dissolution or oxidation while a lithium secondary battery is in use and various materials can be used for the positive electrode collector.

A positive electrode mixture layer is formed by applying a positive electrode mixture slurry to the surface of the positive electrode collector. The positive electrode mixture slurry is produced by adding and dispersing 1-methyl-2-pyrrolidone as a solvent to LiNi_{1/3}Co_{1/3}Mn_{1/3}O₂ (93-x) % by weight as the positive electrode active material, a conductive agent x % by weight, and PVDF (polyvinylidene difluoride) 7% by weight. For the dispersion, a known kneading machine or dispersing machine may be used. As a conductive agent, a plurality of positive electrode active material slurries is produced by changing the ratio of the fibrous conductive agent and the particulate conductive agent. The carbon nanotube (CNT) or carbon fiber is used as the fibrous conductive agent and acetylene black is used as the particulate conductive agent.

The solvent is not limited to 1-methyl-2-pyrrolidone and only needs to dissolve the binder and thus, the solvent may be selected in accordance to the type of binder. The positive electrode active material mixture slurry produced as described above is applied to the positive electrode collector by the doctor blade and dried. The drying temperature is set to 100 to 300° C. Then, after a positive electrode active material mixture layer is formed by roll pressing, a positive electrode is produced by cutting the positive electrode active material mixture layer to an appropriate size. In addition to the doctor blade, the dipping method, the spraying method or the like can be used as the method of applying the positive electrode active material mixture slurry to the positive electrode collector. A laminated structure of a plurality of positive electrode mixture layers may also be formed by performing the application of the positive electrode active material mixture slurry and drying a plurality of times.

As the positive electrode active material, instead of LiNi_{1/3}Co_{1/3}Mn_{1/3}O₂, a Li₂MnO₃—LiMO₂ based solid solution with more capacities may be used. Also, a 5V based positive electrode (such as LiNi_{0.5}Mn_{1.5}O₄) with more power may be used. If one of these materials is used as the positive electrode active material, the positive electrode mixture thickness can be made thinner so that the area of the positive electrode that can be housed in a lithium secondary battery can be increased. As a result, the resistance of the lithium secondary battery decreases to output more power and at the same time, an increase in capacity of the lithium secondary battery can be expected.

The suitable percentage of voids of the electrode to obtain the effect of the present invention is 40% or more and 70% or less with respect to an apparent volume of the mixture layer. If the percentage of voids is 40% or more, the electrolytic solution can come into contact with all particles of the active material contained in the electrode and the electrode can charge and discharge. As a result, active material particles incapable of charging and discharging arise. If the percentage of voids is 70% or less, particularly 55% or less, an electric connection between particles is present and an electrolytic solution holding amount increases with an increasing void volume, which makes the charge and discharge easier.

(Negative Electrode)

The negative electrode 12 is produced by a negative electrode mixture layer being formed on the surface of a negative electrode collector. The negative electrode mixture layer includes a negative electrode active material, a conductive agent, and a binder. Natural graphite coated with amorphous carbon is used as the negative electrode active material. To form amorphous carbon and coat the surface of natural graphite particles therewith, a method of depositing pyrolytic carbon in natural graphite particles is known. If, for example, low-molecular hydrocarbon such as ethane, propane, or butane is diluted with an inert gas such as argon and then heated at 800 to 1200° C., hydrogen is eliminated from hydrocarbon on the surface of natural graphite particles so that carbon is deposited on the surface of natural graphite particles. Carbon deposited on the surface of natural graphite particles is amorphous. Separately, a method of mixing organic matter such as polyvinyl alcohol or cane sugar with natural graphite particles and then heat-treating the mixture in an inert gas atmosphere at 300 to 1000° C. is also known. According to this method, hydrogen, carbon monoxide, and carbon dioxide are eliminated from the mixed organic matter by heat treatment and as a result, only carbon can be deposited on the surface of natural graphite particles.

In the present embodiment, 1% of propane and 99% of argon are mixed and a gas heated up to 1000° C. was brought into contact with natural graphite particles to deposit carbon of 2% by weight on the particle surface. The amount of deposited carbon is preferably in the range of 1 to 30% by weight. By coating the surface of natural graphite particles with amorphous carbon, not only the discharge capacity in the first cycle is increased in a lithium secondary battery, but also cycle life characteristics and discharge rate characteristics are effectively improved.

In the negative electrode 12, the thickness of the negative electrode mixture layer is preferably 10 μm or more and particularly preferably 50 μm or less. If the thickness of the negative electrode mixture layer exceeds 50 μm, the state of charge of the negative electrode active material varies in the interface between the negative electrode mixture layer and the negative electrode collector, biasing the charge and discharge. If the amount of the conductive agent is increased for the purpose of preventing the phenomenon, the volume of the negative electrode mixture layer increases, leading to a lower energy density of the battery. The percentage of voids of the negative electrode mixture layer is preferably 30% or more and 55% or less. If the percentage of voids is less than 30%, it becomes difficult for the electrolytic solution to come into contact with all negative electrode active material particles, making it difficult for a portion of the negative electrode active material to charge and discharge. On the other hand, if the percentage of voids exceeds 55%, contact between negative electrode active material particles is less likely, making it impossible to exchange electrons with a portion of negative electrode active material particles. The average particle size of the negative electrode active material is preferably 1 μm or more and 5 μm or less.

The conductive agent is a fibrous conductive agent or a mixture of a fibrous conductive agent and a particulate conductive agent and the aspect ratio (ratio of the diameter to the length of the conductive fiber) of the fibrous conductive agent is 20 or more. The total volume of the fibrous conductive agent contained in the conductive agent is preferably 0.04% or more and 0.5% or less of the total volume of the binder. The fibrous conductive agent is preferably one of the carbon nanotube and carbon fiber and the total mass of the fibrous conductive agent is preferably 0.1% or more of the total mass of the negative electrode active material. The carbon fiber is preferably vapor growth carbon fiber.

The lower limit of the length of the fibrous conductive agent is preferably larger than the average radius of the negative electrode active material. On the other hand, if the fibrous conductive agent is flexible, the upper limit of the length of the fibrous conductive agent is not particularly set and if the rigidity thereof is relatively high, for example, the fibrous conductive agent is vapor growth carbon fiber, the length thereof is preferably smaller than double the average radius of the negative electrode active material (that is, the average particle size of the negative electrode active material). For example, the length of the fibrous conductive agent can be set to 1 to 10 μm. The diameter of the fibrous conductive agent is preferably 1 to 500 nm and particularly preferably 10 to 200 nm. The fibrous conductive agent preferably couples a plurality of negative electrode active materials by constituting a self-organizing conductive network while being held by the binder. Only the fibrous conductive agent may be used or a mixture of the fibrous conductive agent and particulate conductive agent may be used as the conductive agent. As the particulate conductive agent, particulate carbon such as acetylene black, carbon black, graphite, and amorphous carbon can be used. The particle size of the particulate conductive agent is smaller than the average particle size of the negative electrode active material and is preferably 1/10 or less of the average particle size.

The negative electrode mixture layer preferably does not contain negative electrode active material particles whose size exceeds the thickness of the negative electrode mixture layer. If large negative electrode active material particles whose size exceeds the thickness of the negative electrode mixture layer are contained, electronic conductivity between neighboring negative electrode active material particles is considered to deteriorate. Therefore, it is preferable to remove such large negative electrode active material particles in advance by sieve classification, wind-flow classification or the like.

(Production of the negative electrode) Next, the production of the negative electrode will be described. A negative electrode collector is prepared. Copper foil of 10 to 100 μm in thickness, punched foil made of copper whose thickness is 10 to 100 μm and having many holes of 0.1 to 10 mm in hole diameter formed therein, expanded metal, foamed copper plate or the like can be used as the negative electrode collector. In addition to copper, stainless steel, titanium, or nickel can be used as the material thereof. No restriction is imposed on the material, shape, or manufacturing method that does not undergo a change such as dissolution or oxidation while a lithium secondary battery is in use and various materials can be used for the negative electrode collector. In the present embodiment, rolled copper foil of 10 μm in thickness is used.

A negative electrode mixture layer is formed by applying a negative electrode mixture slurry to the surface of the negative electrode collector. The negative electrode mixture slurry is produced by adding and dispersing 1-methyl-2-pyrrolidone as a solvent to natural graphite particles whose surface is coated with amorphous carbon of (96-x) % by weight as the negative electrode active material, a conductive agent of x % by weight, and PVDF (polyvinylidene difluoride) of 4% by weight. For the dispersion, a known kneading machine or dispersing machine may be used. As a conductive agent, a plurality of negative electrode active material slurries is produced by containing carbon nanotubes of 0.1% or more of the mass of the negative electrode active material.

As the conductive agent, acetylene black or the like may be mixed. Instead of PVDF, styrene-butadiene rubber and carboxymethyl cellulose may be used as the binder and instead of N-methyl-2-pyrrolidone, a water based solvent may be used as the solvent. Various materials that are decomposed on the surface of the negative electrode and are not dissolved in the electrolytic solution can be used as the binder and also fluororubber, ethylene propylene rubber, polyacrylic acid, polyimide, and polyamide can be used.

The solvent is not limited to 1-methyl-2-pyrrolidone and only needs to dissolve the binder and thus, the solvent may be selected in accordance to the type of binder. The negative electrode active material mixture slurry produced as described above is applied to the negative electrode collector by the doctor blade and dried. The drying temperature is set to 100 to 300° C. Then, after a negative electrode active material mixture layer is formed by roll pressing, a negative electrode is produced by cutting the negative electrode active material mixture layer to an appropriate size. In addition to the doctor blade, the dipping method, the spraying method or the like can be used as the method of applying the negative electrode active material mixture slurry to the negative electrode collector. A laminated structure of a plurality of negative electrode mixture layers may also be formed by performing the application of the negative electrode active material mixture slurry and drying a plurality of times.

As the negative electrode active material, the natural graphite is used as an active material, but silicon, tin, or compounds (such as oxide, nitride, or alloys with other metals) of respective elements may also be used. The theoretical capacities of these materials are 500 to 1500 Ah/kg, which is larger than the theoretical capacity (372 Ah/kg) of graphite. Therefore, when one of these materials is used as the negative electrode active material, it is expected that the thickness of the negative electrode mixture layer is made thinner and the area of the negative electrode that can be accommodated in a battery container is increased. A battery using such a negative electrode can be expected to decrease the battery resistance so that high power output and high capacities can be obtained.

In the present embodiment, when a positive electrode active material layer is formed and also when a negative electrode active material layer is formed, the respective active material layer mixture slurry is applied to the respective collector and then maintained at 100 to 300° C. for drying. The temperature is high as a temperature needed to dry the solvent. By maintaining the active material mixture layer in such a high-temperature state, the binder is made fluid and the fibrous conductive agent is rearranged and as a result, constituting a conductive network in which the fibrous conductive agent is self-organized while being held by the binder can be considered. That is, an excellent conductive network is considered to be formed.

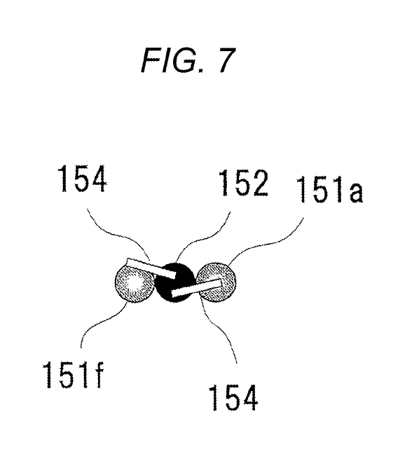

A state in which the fibrous conductive agent is self-organized while being held by the binder to constitute a conductive network is schematically shown in FIG. 7. FIG. 7 shows a state in which the active material particle 152 is in contact with the other active material particles 151a, 151f. Further, a fibrous conductive agent 154 is in contact with the active material particles 152, 151a and the other fibrous conductive agent 154 is in contact with the active material particles 152, 151f. In this manner, a plurality of active material particles in contact with each other is connected by the fibrous conductive agent. That is, the fibrous conductive agent is self-organized while being held by the binder to constitute a conductive network. While the fibrous conductive agent 154 is actually held by the binder, no binder is illustrated in FIG. 7 to make the description easier. By adopting such a configuration, even if a gap arises between active material particles after the charge and discharge being repeated in a lithium secondary battery, conductivity between active material particles is considered to be maintained by the fibrous conductive agent. That is, a solid conductive network is constituted.

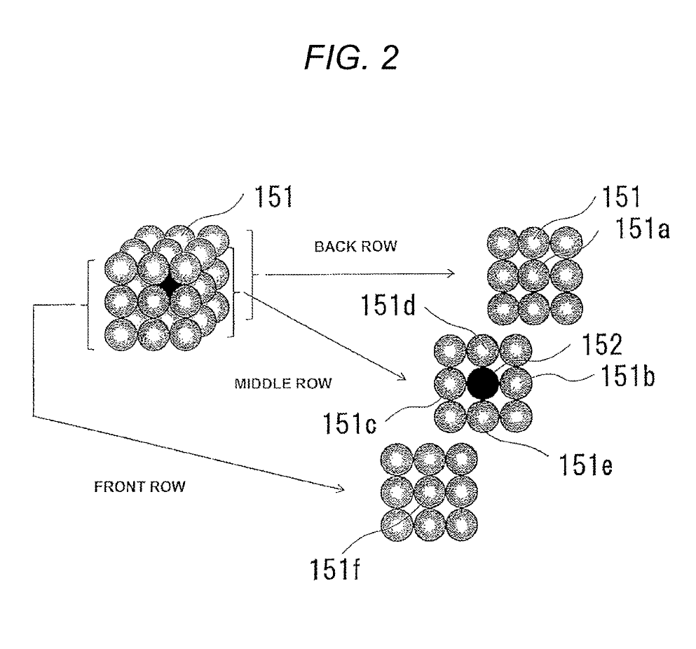

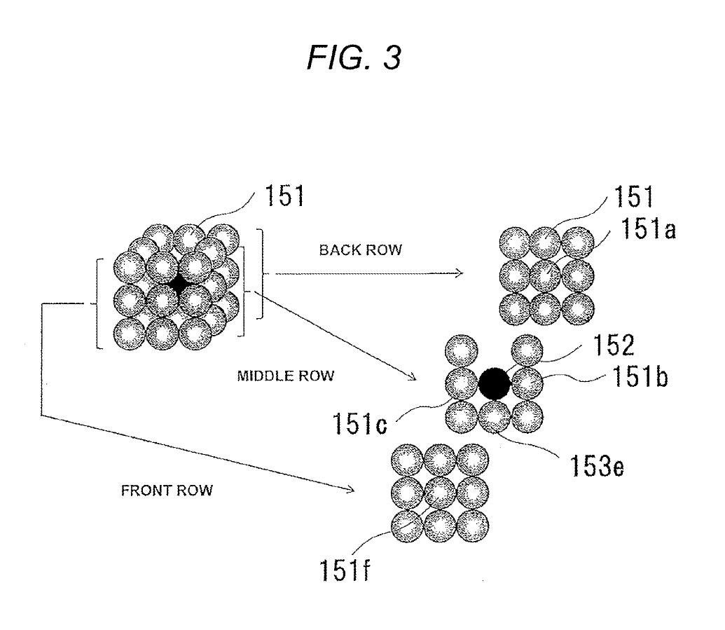

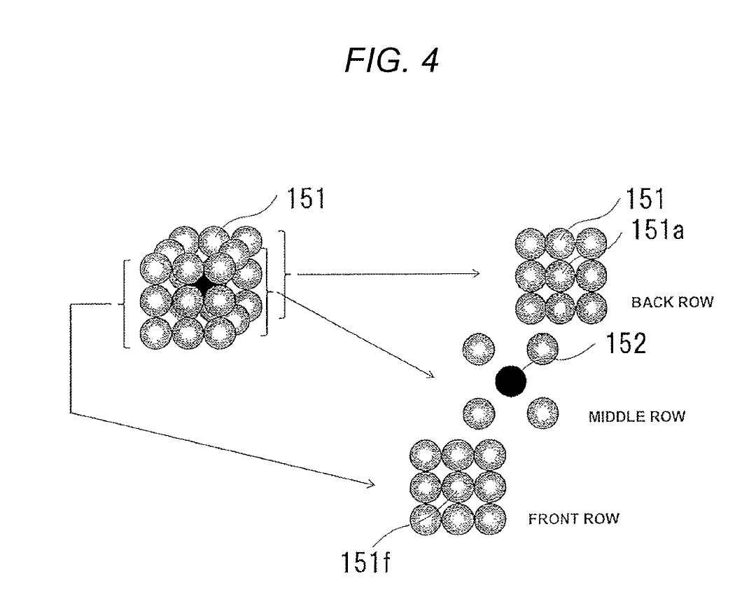

In an actual active material mixture layer, active material particles are not completely spherical and the closest packing structure as shown in FIGS. 2, 3, and 4 is not formed. Even in such a case, however, an effect similar to the effect described with reference to FIG. 7 is obtained. The percentage of voids in such a case tends to be larger than the percentage of voids calculated by assuming the configuration shown in those diagrams by 5 to 15%.

If the length of the fibrous conductive agent is larger than the average radius of active material particles, two active material particles can be coupled more effectively. If the length of the fibrous conductive agent is smaller than the average radius of active material particles, the possibility of coupling other active material particles than the two active material particles to be coupled decreases and the stress on the fibrous conductive agent can thereby be limited. If the aspect ratio of the fibrous conductive agent is smaller than 20, self-organization is less likely to occur and the structure as shown in FIG. 7 is not obtained.

Whether the fibrous conductive agent is self-organized while being held by the binder can be verified by observing the surface of an active material mixture layer of an electrode through a scanning electron microscope. If the fibrous conductive agent is self-organized while being held by the binder, a shape in which a plurality of fibrous conductive agents is stacked and linked can be observed on the surface of the active material mixture layer.

As another method of verifying whether the fibrous conductive agent is self-organized while being held by the binder, the resistance is measured by changing the mixing ratio of the fibrous conductive agent with the binder. If, for example, the mixing ratio of the fibrous conductive agent to the binder is 10 to 20% by volume, it is possible to determine that self-organization occurs with an extremely small resistance.

(Separator)

A material of a multi-layered structure in which a polyolefine polymeric sheet made of polyethylene, polypropylene or the like or a fluorine based polymeric sheet represented by polyolefine polymers or polytetrafluoro polyethylene is welded can be used for the separator. To inhibit the contraction of the separator when the battery temperature rises, a separator having a thin layer of a mixture of ceramics and a binder formed on the surface thereof may be used. The separator needs to allow lithium ions to pass through when the battery charges or discharges and thus, has generally many pores whose diameter is 0.01 to 10 μm and the percentage of voids thereof is 20 to 90%. In the present embodiment, a polyethylene single-layer separator of 25 μm in thickness having the percentage of voids of 45% is used.

(Production of the Electrolytic Solution)

In the present embodiment, a solution obtained by dissolving lithium hexafluorophosphate (LiPF₆) or lithium tetrafluoroborate (LiBF₄) as an electrolyte in a solvent in which one or two or more of dimethyl carbonate, diethyl carbonate, and ethylmethyl carbonate are mixed in ethylene carbonate can be used. However, the present embodiment is not limited to the above solvents and electrolytes and various materials can be used. Also, the electrolyte can be used in a state of being contained in an ionic conductive polymer such as polyvinylidene difluoride, polyethylene oxide or the like. In such a case, the separator is not needed.

Solvents other than the above solvents that can be used for the electrolytic solution include nonaqueous solvents such as propylene carbonate, ethylene carbonate, butylene carbonate, vinylene carbonate, γ-butyrolactone, dimethyl carbonate, diethyl carbonate, methylethyl carbonate, 1,2-dimethoxy-ethane, 2-methyltetrahydrofuran, dimethyl sulfoxide, 1,3-dioxolane, formamide, dimethylformamide, methyl propionate, ethyl propionate, triester phosphate, trimethoxymethane, dioxolane, diethyl ether, sulfolane, 3-methyl-2-oxazolidinone, tetrahydrofuran, 1,2-diethoxy-ethane, chloroethylene carbonate, and chloropropylene carbonate. Other solvents than the above ones may also be used for a material that is not decomposed in the positive electrode or the negative electrode.

As the electrolyte, various lithium salts such as LiPF₆, LiBF₄, LiClO₄, LiCF₃SO₃, LiCF₃CO₂, LiAsF₆, LiSbF₆, and lithium imide salt including lithium trifluoromethane sulfonimide can be used. Other electrolytes than the above ones may also be used for a material that is not decomposed in the positive electrode or the negative electrode.

Also, a gel electrolyte may be used. As the gel electrolyte, for example, a mixture of polyvinylidene difluoride and nonaqueous electrolytic solution can be used. Instead of using the electrolytic solution, a solid polymeric electrolyte (polymer electrolyte) can be used. As the solid polymeric electrolyte, for example, ionic conductive polymers such as polyethylene oxide, polyacrylonitrile, polyvinylidene difluoride, polymethyl methacrylate, and polyhexafluoropropylene can be cited. When one of such solid polymeric electrolytes is used, the separator may be omitted.

As the electrolytic solution, an ionic liquid may be used. For example, a combination that is not decomposed in the positive electrode and the negative electrode can be selected and used from 1-ethyl-3-methylimidazolium tetrafluoroborate (EMI-BF₄), a mixed complex of lithium salt LiN(SO₂CF₃)₂ (LiTFSI), triglyme, and tetraglyme, and annular quaternary ammonium based cations (for example, N-methyl-N-propylpyrrolidinium) and imide based anions (for example, bis(fluorosulfonyl)imide).

In the present embodiment, a liquid obtained by dissolving LiPF₆ in a mixed solvent of ethylene carbonate (hereinafter, abbreviated as EC) and ethylmethyl carbonate (hereinafter, abbreviated as EMC) so as to obtain 1 mol concentration (1M=1 mol/dm³) was used as the electrolytic solution. The mixing ratio of EC and EMC was set to 1:2 by volume. Incidentally, vinylene carbonate was added to the electrolytic solution so as to be 1% by weight.

### EXAMPLES

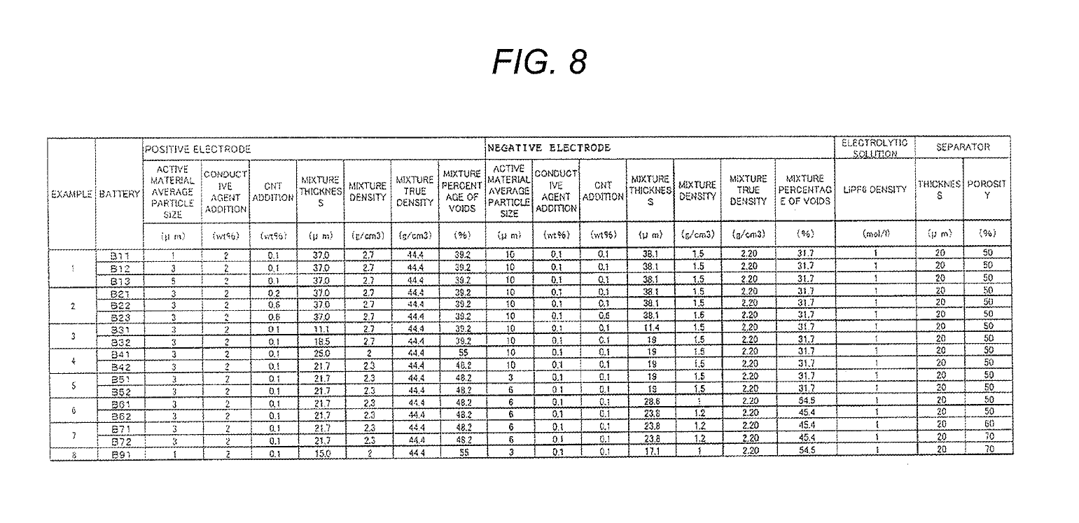

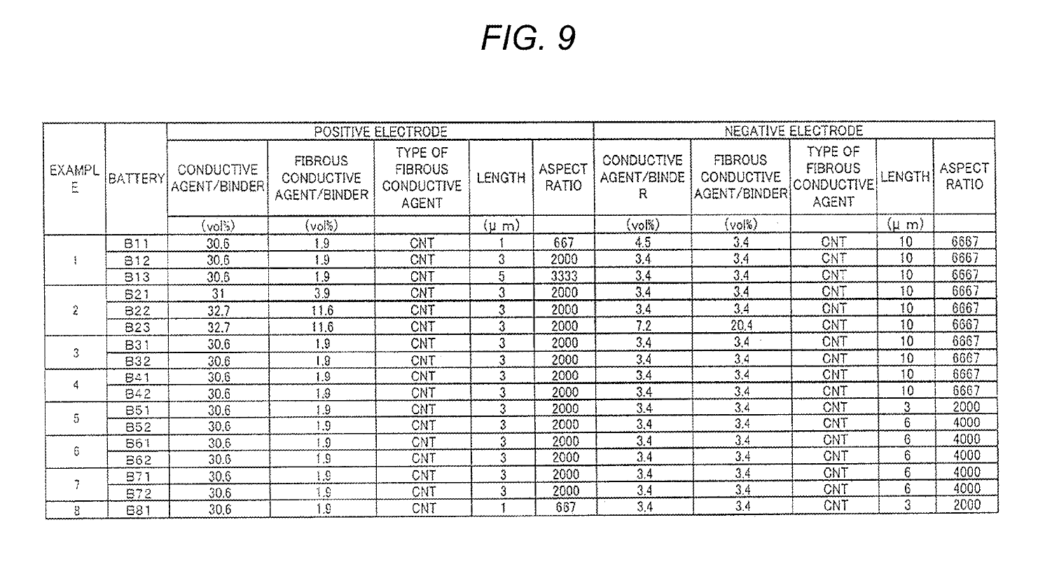

An electrode group is constituted by inserting the separator 11 between the positive electrode 10 and the negative electrode 12. The separator 11 is also inserted between an electrode portion positioned at an end of the electrode group and the battery container 13 so that the positive electrode 10 and the negative electrode 12 are not short-circuited through the battery container 13. After inserting the electrode group into the battery container 13, an electrolytic solution made of an electrolyte and a nonaqueous solvent is injected and the battery container 13 is sealed with the battery lid 20. Accordingly, the surface of the separator 11, the positive electrode 10, and the negative electrode 12 and the electrolytic solution in voids thereof are held. A plurality of lithium secondary batteries of various combinations shown in tables in FIGS. 8 and 9 was produced. These lithium secondary batteries are grouped as Example 1 to Example 8 based on the trend of the configuration. In FIG. 8, the conductive agent addition and CNT addition are shown as % by weight with respect to the active material in each electrode.

The percentage of voids was determined by the following formula by measuring true densities of the active material, conductive agent, and binder and an apparent density of the mixture layer.

Percentage of voids=100−(apparent mixture density)÷(true density of the mixture)×100

True density of the mixture=100÷(% by weight of the active material÷true density of the active material+% by weight of the conductive agent÷true density of the conductive agent+% by weight of the binder÷true density of the binder)

The apparent mixture density is a value obtained by dividing the weight of the mixture layer by the product of the mixture area and the thickness thereof. Compositions of the active material, the conductive agent, the true density 2.2 g/cm³ of the negative electrode active material, and the binder are fraction converted values. More specifically, the true density 5.0 g/cm³ of the positive electrode active material, the true density 1.3 g/cm³ of the fibrous conductive agent, the true density 1.8 g/cm³ of other conductive agents, and the true density 1.8 g/cm³ of the binder are used. As the fibrous conductive agent, CNT is used for all cases. As the remaining particulate conductive agent of CNT, carbon black is used. The average diameter of CNT is 1.5 nm and the ratio of the length thereof to the average particle size of active material particles of the positive electrode and the negative electrode is set to ½ to 1. The aspect ratio of CNT is in the range of 667 to 3400. The ratio of the CNT volume to the binder volume was in the range of 0.1 to 0.5%, in both of the positive electrode and the negative electrode.

The rated capacity of batteries produced as Example 1 to Example 8 is 3.0 Ah. The rated capacity of 3 Ah was achieved by changing the area and the number of electrodes in accordance with the coated amount of active material mixture on the collector.

(Evaluation of the Battery Performance)

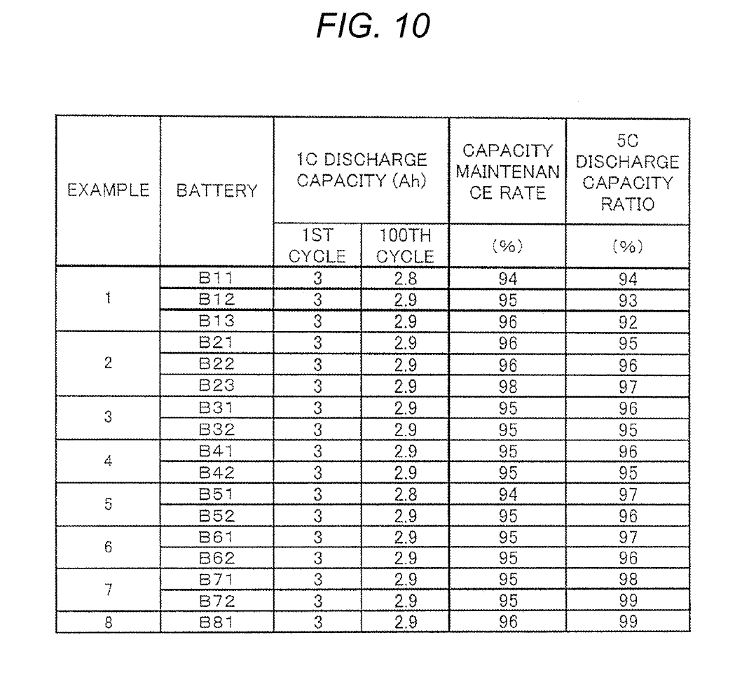

An initial aging process of these batteries was performed. More specifically, the battery is charged with a charge current 2.5 A until the battery voltage 4.2 V was reached and then while maintaining the voltage, the charge was continued until the charge current becomes 0.05 A. Next, after setting the pause of 30 min., the discharge was started with the discharge current 5 A and was stopped when the battery voltage reaches 2.8 V. Next, the pause of 30 min. was set. The charge and discharge described above were repeated five times to complete the initial aging process. The last (fifth) discharge capacity was set as the discharge capacity of the first cycle. The value is shown in the table in FIG. 10 as the 1C discharge capacity.

Next, the discharge capacity was measured by setting the charge condition in the same manner as in the initial aging process and the discharge current to five times (25 A) the discharge current in the initial aging process. This was set as the 5C discharge capacity and the ratio of the 5C discharge capacity to the 1C discharge capacity was set as the 5C discharge capacity ratio. These values are shown in the table in FIG. 10.

Next, the cycle test in which the charge and discharge were repeated under the same conditions as those of the charge and discharge in the initial aging process was performed. One charge and discharge was counted as one cycle and the discharge capacity in the 100th cycle was measured. Also, the ratio of the discharge capacity in the 100th cycle to the capacity in the first cycle was set as the capacity maintenance rate. These values are shown in the table in FIG. 10.

The capacity maintenance rate of each battery grouped as Example 2 is relatively high. Each of these batteries has a large CNT addition to the positive electrode mixture layer. Thus, a high capacity maintenance rate due to improved conductivity can be estimated.

The 5C discharge capacity ratio of each battery grouped as Examples 3 and 8 is relatively good. Each of these batteries has a positive electrode mixture layer that is relatively thin. The 5C discharge capacity ratio of each battery grouped as Examples 5 to 8 is relatively good. Each of these batteries has a relatively small particle size of the negative electrode active material. The 5C discharge capacity ratio of each battery grouped as Examples 7 and 8 is relatively good. Each of these batteries has a relatively large percentage of voids of the separator. A battery B81 in Example 8 is configured based on Examples 1 to 7 and exhibits the best performance in both of the capacity maintenance rate and the 5C discharge capacity ratio.

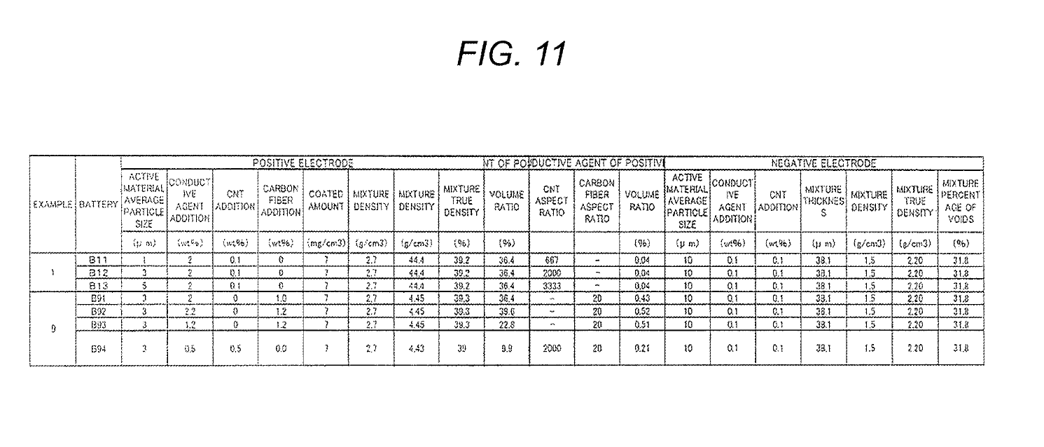

Batteries B91 to B93 of each battery grouped as Example 9 uses vapor growth carbon fiber as the fibrous conductive agent and does not use CNT. The average diameter of the vapor growth carbon fiber was 0.15 μm and the length thereof was 3 μm. This length corresponds to the average particle size of the positive electrode active material. A battery B94 does not use a particulate conductive agent as the conductive agent and uses only CNT as the fibrous conductive agent. The configurations of the batteries B91 to B94 are shown in the table in FIG. 11 in contrast with batteries B11 to B13 grouped as Example 1. Incidentally, the negative electrode of the batteries B91 to B94 has the same configuration as that used for each battery in Example 1.

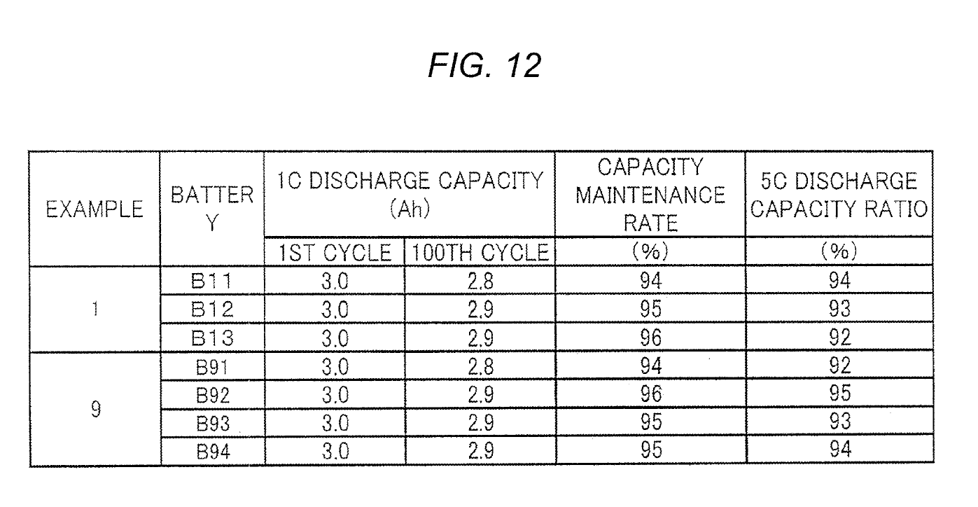

The battery performance of each battery of Example 9 was evaluated according to the procedure used for each battery in Examples 1 to 8. The result is shown in the table in FIG. 12. As shown in FIG. 12, each battery of Example 9 shows values as good as those of Examples 1 to 8 both in the capacity maintenance rate and the 5C discharge capacity ratio.

### COMPARATIVE EXAMPLES

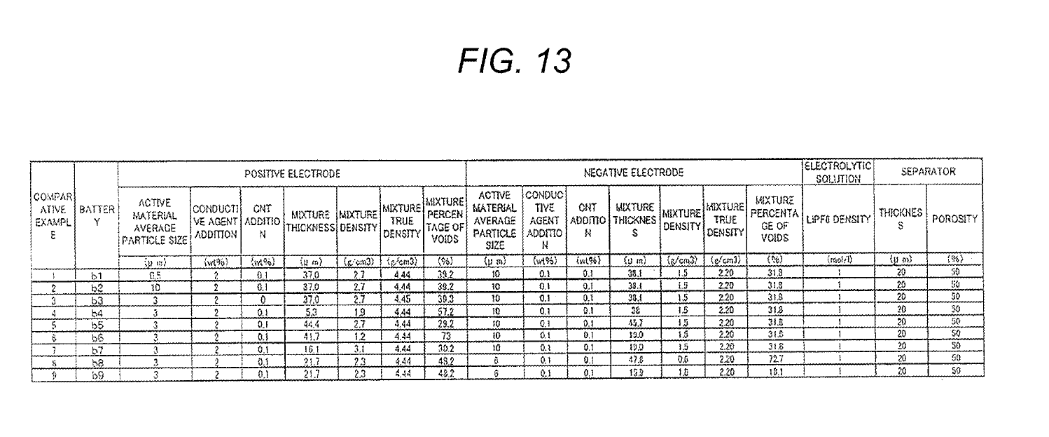

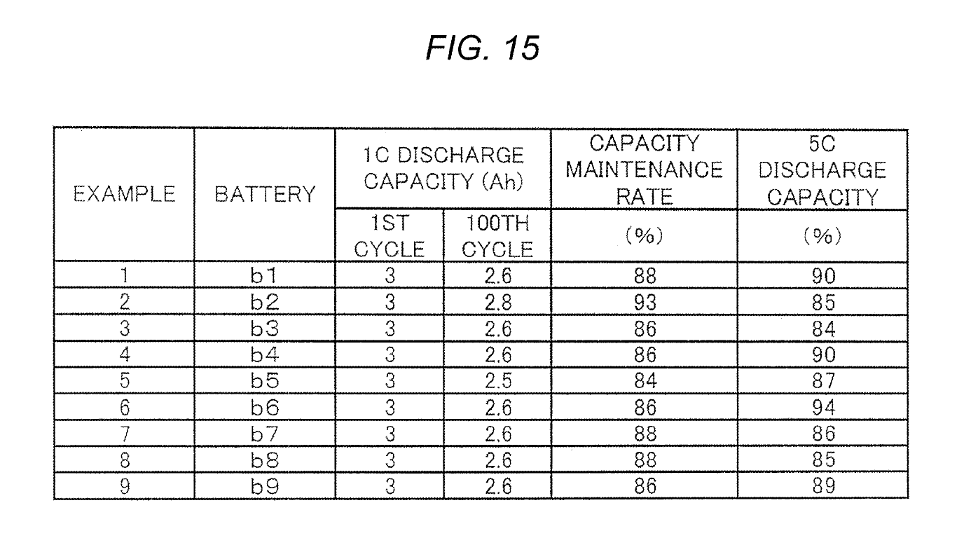

A plurality of lithium secondary batteries as comparative examples were produced based on configurations shown in the table in FIG. 13. These lithium secondary batteries are grouped as Comparative Example 1 to Comparative Example 9 based on the trend of the configuration. The battery performance of these batteries was evaluated according to the procedure similar to that used for each battery of Examples. The result is shown in the table in FIG. 15. Based on comparison of the battery performance of comparative examples shown in FIG. 15 and the battery performance of examples shown in FIGS. 10 and 12, the following reviews was done.

A battery b1 grouped as Comparative Example 1 has a particle size of the positive electrode active material smaller than that of each battery produced as an example. Thus, the specific surface area of the positive electrode active material is too large and a reaction with the electrolytic solution is promoted and therefore, the capacity maintenance rate of the battery b1 is considered to be low. A battery b2 grouped as Comparative Example 2 has a particle size of the positive electrode active material larger than that of each battery produced as an example. Thus, the specific surface area of the positive electrode active material is too small and therefore, the 5C discharge capacity is considered to be low.

A battery b3 grouped as Comparative Example 3 contains no fibrous conductive agent (CNT) in the positive electrode mixture layer. Thus, conductivity between positive electrode active material particles deteriorates and as a result, the capacity maintenance rate and the 5C discharge capacity are both considered to be low. A battery b4 grouped as Comparative Example 4 has a low capacity maintenance rate. The low capacity maintenance rate is estimated to result from a low density of the positive electrode mixture layer because the positive electrode mixture layer is thin and compression of the positive electrode mixture layer is not effectively performed by pressing. A battery b5 grouped as Comparative Example 5 has a thick positive electrode mixture layer. This is estimated to be the cause that the capacity maintenance rate and the 5C discharge capacity are both low.

A battery b6 grouped as Comparative Example 6 has a low positive electrode mixture density. The positive electrode mixture slurry used to produce the positive electrode of the battery was prepared by increasing the amount of 1-methyl-2-pyrrolidone as a solvent. Because the positive electrode mixture layer is formed by using such a positive electrode mixture slurry, the positive electrode mixture layer is considered to have a low density. Thus, the contact between positive electrode active material particles is poor and the positive electrode resistance increases, which can be considered to be the cause of a low capacity maintenance rate.

A battery b7 grouped as Comparative Example 7 has a high positive electrode mixture density. Thus, voids between positive electrode active material particles decrease and infiltration of the electrolytic solution is inhibited and thus, the capacity maintenance rate and the 5C discharge capacity are both considered to be low. A battery b8 grouped as Comparative Example 8 has a low negative electrode mixture density. The negative electrode mixture slurry used to produce the negative electrode of the battery is prepared by increasing the amount of water as a solvent. Because the negative electrode mixture layer is formed by using such a negative electrode mixture slurry, the negative electrode mixture layer is considered to have a low density. Thus, the contact between negative electrode active material particles is poor and the negative electrode resistance increases, which can be considered to be the cause of a low capacity maintenance rate. A battery b9 grouped as Comparative Example 9 has a high negative electrode mixture density. Thus, voids between negative electrode active material particles decrease and infiltration of the electrolytic solution is inhibited and thus, the capacity maintenance rate and the 5C discharge capacity are both considered to be low.

### Second Embodiment

### Power Storage Apparatus

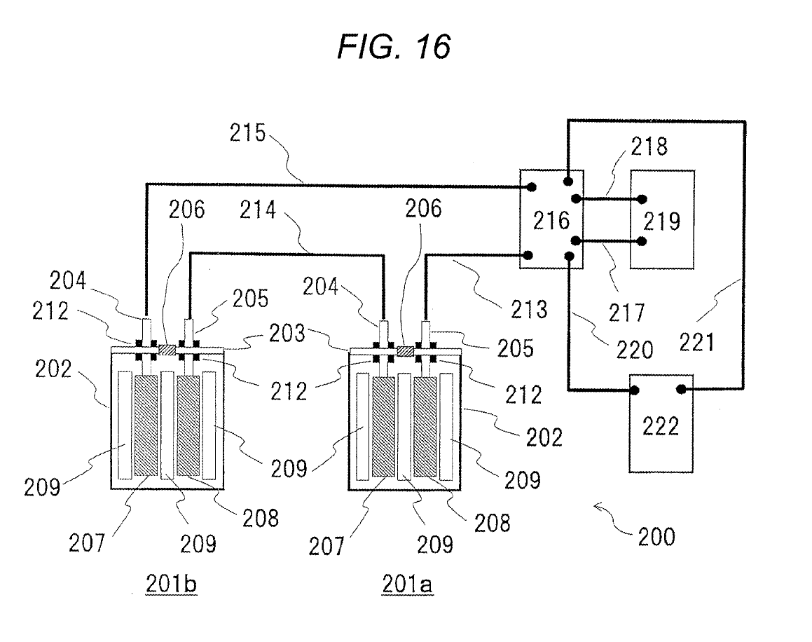

Eight lithium secondary batteries of the rated capacity 10 Ah were produced by increasing the areas of the positive electrode and the negative electrode of the battery B81 in Example 8. These eight lithium secondary batteries were connected in series to produce a power storage apparatus. FIG. 16 is a conceptual diagram showing an outline configuration of a charging apparatus 200. In FIG. 16, a configuration in which two lithium secondary batteries are connected in series is shown to make the configuration easier to understand. In FIG. 16, reference numerals 201a and 201b represent lithium secondary batteries and reference numeral 216 represents a charge and discharge controller. Incidentally, lithium secondary batteries may be connected in series or in parallel and the number of batteries connected in series or in parallel may be any number and can be determined in accordance with the DC voltage and electric energy required of the system.

Each of the lithium secondary batteries 201a, 201b has an electrode group including a positive electrode 207, a negative electrode 208, and a separator 209 and a battery lid 203 in an upper portion is provided with a positive electrode external terminal 204, a negative electrode external terminal 205, and a liquid injection port 206. An insulating seal member 212 is inserted between each external terminal and the battery container to prevent the external terminals from short-circuiting. The negative electrode external terminal 205 of the lithium secondary battery 201a is connected to a negative electrode input terminal of the charge and discharge controller 216 by a power cable 213. The positive electrode external terminal 204 of the lithium secondary battery 201a is connected to the negative electrode external terminal 205 of the lithium secondary battery 201b via a power cable 214. The positive electrode external terminal 204 of the lithium secondary battery 201b is connected to a positive electrode input terminal of the charge and discharge controller 216 by a power cable 215.

The charge and discharge controller 216 exchanges power with a device installed outside (hereinafter, called an external device) 219 via power cables 217, 218. The external device 219 represents an external power supply to supply power to the charge and discharge controller 216, various electric devices such as a regenerative motor, or an inverter, a converter, or a load to which the charge and discharge controller supplies power.

Reference numeral 222 represents, for example, a wind turbine generator as a device that generates renewable energy. The power generating apparatus 222 is connected to the charge and discharge controller 216 via power cables 220, 221. When the power generating apparatus 222 generates power, the charge and discharge controller 216 is set to a charging mode and supplies power to the external device 219 and also exercises control such that surplus power is charged in the lithium secondary batteries 201a, 201b. If the electric power generation of the wind turbine generator is less than required power of the external device 219, the charge and discharge controller 216 exercises control such that the lithium secondary batteries 201a, 201b are caused to discharge. The power generating apparatus 222 may be a power generating apparatus other than the wind turbine generator, for example, an apparatus of solar power generation, a geothermal power generating apparatus, a fuel cell, a gas turbine generator or the like. The charge and discharge controller 216 is caused to store a program to exercise the above control in advance.

The external device 219 supplies power to the lithium secondary batteries 201a, 201b via the charge and discharge controller 216 when the lithium secondary batteries 201a, 201b are charged and consumes power from the lithium secondary batteries 201a, 201b via the charge and discharge controller 216 when the lithium secondary batteries 201a, 201b are discharged.

In the present embodiment, for the purpose of checking the function of the power storage apparatus in the present embodiment, instead of the external device, a feed/load power supply having both functions of the supply and consumption of power was connected. Using only the feed/load power supply, the effect of the present power storage apparatus in actual use of an electric vehicle such as an electric car, a machine tool, a distributed power storage system, a backup power supply system and the like can adequately be checked.

The present power storage apparatus was charged for the first time at the constant voltage of 33.6 V for one hour by passing a charge current of a current value (10 A) of one hour rate to the positive electrode external terminal 204 and the negative electrode external terminal 205 from the charge and discharge circuit 219. The constant voltage of 33.6V corresponds to eight times the constant voltage value 4.2 V of one lithium secondary battery used for the present power storage apparatus. The power needed for the charge and discharge of the present power storage apparatus was supplied from the feed/load apparatus 219.

For the discharge, the feed/load apparatus 219 was caused to consume power by passing a current in a reversed direction from the positive electrode external terminal 204 and the negative electrode external terminal 205 to the charge and discharge circuit. One hour rate condition (5 A as a discharge current) was set to the discharge current and the discharge was continued until the inter-terminal voltage between the positive electrode external terminal 204 and the negative electrode external terminal 205 reached 22.4 V. By performing the charge and discharge as described above, the initial performance of the charge capacity 10 Ah and the discharge capacity 9.6 to 10 Ah was obtained. Further, the capacity maintenance rate of 94 to 96% was obtained after performing a charge and discharge cycle test of 300 cycles.

The present invention is not limited to the above-described embodiment. Concrete constituent materials and members may be changed without altering the spirit of the present invention. If elements of the present invention are included, an addition of a publicly known technology or a replacement by a publicly known technology may be made.

Carbon materials and battery modules in the present invention can be used for, in addition to consumer products such as mobile electronic devices, mobile phones, and electric power tools, electric cars, electric trains, accumulators for renewable energy storage, unmanned cars, and power supplies of care devices. Further, a lithium secondary battery of the present invention can be applied to the power supply of a logistic train for the exploration of the moon, Mars and the like. Also, a lithium secondary battery of the present invention can be used as various power supplies of space suits, space stations, buildings or the living space (whether closed or open) on the earth or other celestial bodies, spacecraft for interplanetary movement, land rovers, and air conditioning, temperature control, purification of sewage or air, and mechanical power of various spaces such as an underwater or undersea closed state, a submarine, and fish observation equipment.

What is claimed is:

1. A lithium secondary battery having a positive electrode, a negative electrode, and an electrolyte, wherein
the positive electrode is constituted by a positive electrode mixture layer containing a positive electrode active material, a binder, and a conductive agent being formed on a positive electrode collector,
the negative electrode is constituted by a negative electrode mixture layer containing a negative electrode active material, the binder, and the conductive agent being formed on a negative electrode collector,
a thickness of the positive electrode mixture layer is 40 μm or less,
a percentage of voids of the positive electrode mixture layer is 40% or more and 55% or less,
an average particle size of the positive electrode active material is 1 μm or more and 5 μm or less,
a volume of the conductive agent in the positive electrode mixture layer is 10% or more and 40% or less of the volume of the binder, and
the conductive agent contained in both of the positive electrode mixture layer and the negative electrode mixture layer is a fibrous conductive agent or a mixture of the fibrous conductive agent and a particulate conductive agent and an aspect ratio (radio of a diameter to a length of the fibrous conductive agent) of the fibrous conductive agent is 20 or more.

2. The lithium secondary battery according to claim 1, wherein
the percentage of voids of the negative electrode mixture layer is 30% or more and 55% or less, and
the average particle size of the negative electrode active material is 1 μm or more and 5 μm or less.

3. The lithium secondary battery according to claim 1, wherein
the volume of the fibrous conductive agent contained in the conductive agent is 0.04% or more and 0.5% or less of the volume of the binder in each of the positive electrode mixture layer and the negative electrode mixture layer.

4. The lithium secondary battery according to claim 1, wherein
the fibrous conductive agent is at least one of a carbon nanotube and a carbon fiber, and
a mass of the fibrous conductive agent is 0.1% or more of the positive electrode active material in the positive electrode mixture layer and 0.1% or more of the negative electrode active material in the negative electrode mixture layer.

5. The lithium secondary battery according to claim 1, wherein
the length of the fibrous conductive agent contained in the positive electrode mixture layer is larger than an average radius of the positive electrode active material, and
the length of the fibrous conductive agent contained in the negative electrode mixture layer is larger than the average radius of the negative electrode active material.

6. The lithium secondary battery according to claim 5, wherein
the length of the fibrous conductive agent contained in the positive electrode mixture layer is smaller than double the average radius of the positive electrode active material, and
the length of the fibrous conductive agent contained in the negative electrode mixture layer is smaller than double the average radius of the negative electrode active material.

7. The lithium secondary battery according to claim 1, wherein
the fibrous conductive agent couples a plurality of the positive electrode active materials therebetween and a plurality of the negative electrode active materials therebetween by constituting a self-organizing conductive network while being held by the binder in each of the positive electrode mixture layer and the negative electrode mixture layer.

8. A power storage apparatus including a lithium secondary battery, wherein
the lithium secondary battery is the lithium secondary battery according to claim 1.

9. A method of manufacturing the lithium secondary battery according to claim 1, comprising:
forming a positive electrode mixture layer containing a fibrous conductive agent on a positive electrode collector;
forming a negative electrode mixture layer containing the fibrous conductive agent on a negative electrode collector; and
holding the positive electrode collector on which the positive electrode mixture layer is formed and the negative electrode collector on which the positive electrode mixture layer is formed at 100° C. or more and 300° C. or less for a predetermined time.
